(19) United States
(12) Patent Application Publication
(10) Pub. No.: US 2020/0282751 A1
(43) Pub. Date: Sep. 10, 2020

(54) PAPER FEEDING DEVICE AND IMAGE FORMING APPARATUS

(71) Applicant: FUJI XEROX CO., LTD., Tokyo (JP)

(72) Inventors: Misaki SURUGA, Kanagawa (JP); Tatsuo MIYAJI, Kanagawa (JP); Michiaki YOSHIDA, Kanagawa (JP); Shogo FUJITA, Kanagawa (JP)

(73) Assignee: FUJI XEROX CO., LTD., Tokyo (JP)

(21) Appl. No.: 16/533,244

(22) Filed: Aug. 6, 2019

(30) Foreign Application Priority Data
Mar. 4, 2019 (JP) 2019-038286

(51) Int. Cl. B41J 13/10; B41J 29/02; B41J 29/13; B65H 31/00

(52) U.S. Cl. CPC B41J 13/103; B41J 29/02; B65H 2801/12; B65H 31/00; B41J 29/13

(57) ABSTRACT

A paper feeding device includes: a loading unit on which a recording medium is loaded; a pair of walls provided to define a loading space above the loading unit between both sides in a direction intersecting with a direction of transport of the recording medium; an opening and closing member that is provided between upper portions of the pair of walls and opens and closes the loading space; and a cutout part that is provided on one of the pair of walls and in which a portion located upstream in the transport direction is located lower than a portion located downstream in the transport direction.

### CROSS-REFERENCE TO RELATED APPLICATIONS

This application is based on and claims priority under 35 USC 119 from Japanese Patent Application No. 2019-038286 filed Mar. 4, 2019.

### BACKGROUND

### (i) Technical Field

The present disclosure relates to a paper feeding device and an image forming apparatus.

### (ii) Related Art

JP-A-2011-195203 discloses a printer in which a main body case is provided with an opening/closing cover, and a side opening formed in a side surface portion of the main body case is closed by a side plate portion of the opening/closing cover. In the printer, a first paper guide that defines one side end of a paper transporting path inside the printer in a width direction is attached to an inside of the side plate portion, and when the opening/closing cover is opened, the first paper guide is also opened, and the one side end of the paper transporting path becomes an open state.

JP-A-2002-351282 discloses a paper feeding device in which a first exterior cover and a second exterior cover for opening and closing are integrated on the front side of a device main body. In the paper feeding device, only the first exterior cover is opened to the front side of the device main body with respect to the trouble in double-sided printing, and both the first exterior cover and the second external cover are opened to the front side of the device main body with respect to the trouble in single-sided printing.

### SUMMARY

Aspects of non-limiting embodiments of the present disclosure relate to providing a paper feeding device that provides improved workability during placement of recording media on a loading unit as compared with a configuration in which one of a pair of walls has the same upper surface level.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the preset disclosure, there is provided a paper feeding device including: a loading unit on which a recording medium is loaded; a pair of walls provided to define a loading space above the loading unit between both sides in a direction intersecting with a direction of transport of the recording medium; an opening and closing member that is provided between upper portions of the pair of walls and opens and closes the loading space; and a cutout part that is provided on one of the pair of walls and in which a portion located upstream in the transport direction is located lower than a portion located downstream in the transport direction.

### BRIEF DESCRIPTION OF THE DRAWINGS

Exemplary embodiments of the present invention will be described in detail based on the following figures, wherein:

FIG. 1 is a front view showing an image forming apparatus including a paper feeding device according to an exemplary embodiment;

FIG. 2 is a perspective view showing the paper feeding device according to the exemplary embodiment;

FIG. 3 is a perspective view showing a state where a loading space above a loading unit is opened by rotating an opening and closing member and a rotating member used in the paper feeding device according to the exemplary embodiment;

FIG. 4 is a longitudinal sectional view showing a state where the opening and closing member and the rotating member are closed on an upper side of the paper feeding device according to the exemplary embodiment;

FIG. 5 is a side view showing a state where the opening and closing member and the rotating member are open on the upper side of the paper feeding device according to the exemplary embodiment;

FIG. 6A is a front view showing a cutout part of a front wall and a projecting portion of the opening and closing member used in the paper feeding device according to the exemplary embodiment, and FIG. 6B is a sectional view showing the cutout part of the front wall and the projecting portion of the opening and closing member taken along 6B-6B line in FIG. 6A;

FIG. 7 is a side view showing a state where a recording medium is disposed on the loading unit from the front side of the front wall in a part of the paper feeding device according to the exemplary embodiment;

FIG. 8 is a side sectional view showing a reinforcing portion of the opening and closing member used in the paper feeding device according to the exemplary embodiment;

FIG. 9 is a perspective view showing a latch mechanism and a damper of the opening and closing member used in the paper feeding device according to the exemplary embodiment;

FIG. 10 is a side view showing, in an enlarged state, the reinforcing portion of the opening and closing member and a contact surface of a device main body used in the paper feeding device according to the exemplary embodiment;

FIG. 11A is a side view showing a part of the reinforcing portion, and FIG. 11B is a front view showing a part of the reinforcing portion;

FIG. 12 is a side view showing the latch mechanism of the opening and closing member used in the paper feeding device according to the exemplary embodiment;

FIG. 13 is a front view showing the latch mechanism of the opening and closing member used in the paper feeding device according to the exemplary embodiment;

FIG. 14 is a perspective view of the reinforcing portion of the opening and closing member used in the paper feeding device according to the exemplary embodiment when viewed from below;

FIG. 15 is a schematic configuration view showing a state where an external force is applied to a frame portion in a closed state of the opening and closing member in the paper feeding device according to the exemplary embodiment;

FIG. 16 is a perspective view showing a state where a loading space above a loading unit is opened by rotating an opening and closing member and a rotating member used in a paper feeding device according to a first comparative example;

FIG. 17 is a side view showing a state where a recording medium is disposed on the loading unit from the front side of a front wall in a part of the paper feeding device according to the first comparative example;

FIG. 18 is a side sectional view showing a state where the loading space above the loading unit is closed by the opening and closing member in the paper feeding device according to the first comparative example;

FIG. 19 is a schematic configuration view showing a state where an external force is applied to a device main body in a closed state of the opening and closing member in the paper feeding device according to the first comparative example; and

FIG. 20 is a side view showing a state where a recording medium is disposed on a loading unit from the front side of a front wall in a part of a paper feeding device according to a second comparative example.

### DETAILED DESCRIPTION

Hereinafter, a mode for carrying out the present disclosure (hereinafter, referred to as the present exemplary embodiment) will be described. In the following description, it is assumed that in the drawings, a direction indicated by an arrow X is a device width direction, and a direction indicated by an arrow Y is a device height direction. In addition, it is assumed that a direction (arrow Z direction) orthogonal to each of the device width direction and the device height direction is a device depth direction.

Configuration of Image Forming Apparatus

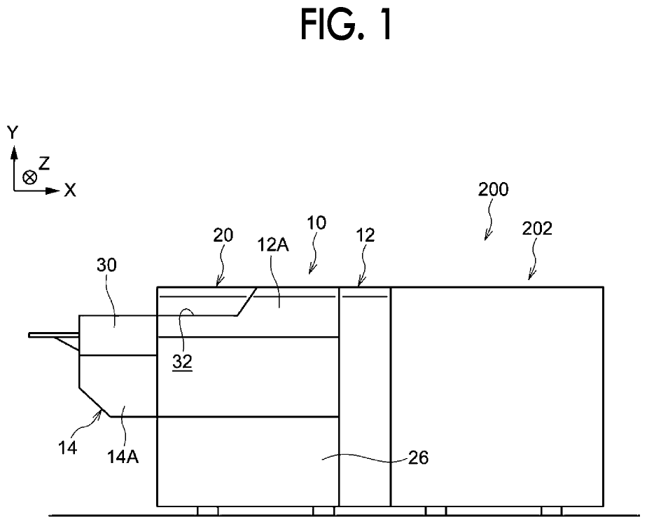

FIG. 1 is a front view showing an example of an image forming apparatus 200 including a paper feeding device 10 according to an exemplary embodiment.

As shown in FIG. 1, the image forming apparatus 200 includes an image forming apparatus main body 202 as an example of an image forming unit that forms an image on a recording medium, and the paper feeding device 10 that feeds the recording medium into the image forming apparatus main body 202. The paper feeding device 10 is disposed adjacent to the side portion of the image forming apparatus main body 202. Although not shown, an image forming unit that forms an image on the recording medium, and a transporting unit that transports the recording medium to the image forming unit are included inside the image forming apparatus main body 202. The configuration and disposition of the image forming unit and the transporting unit are not particularly limited. The paper feeding device 10 is attached to the image forming apparatus main body 202 in an option, and is separately traded.

Configuration of Paper Feeding Device (Overall Configuration)

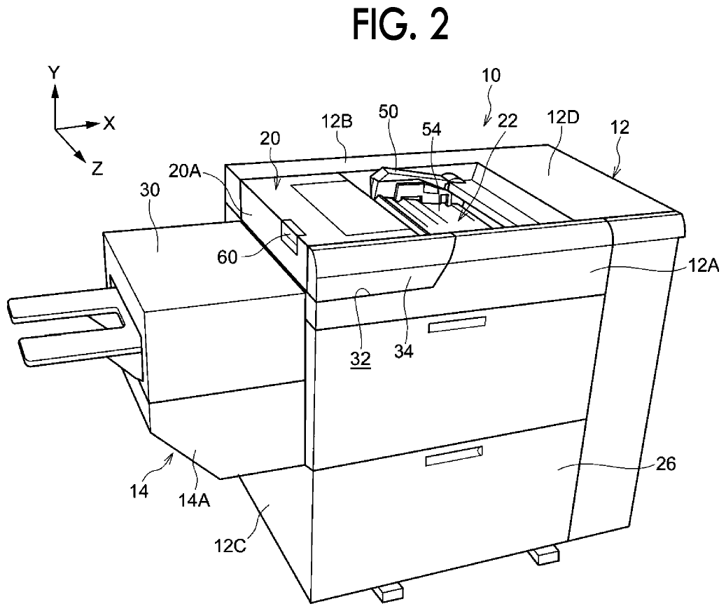

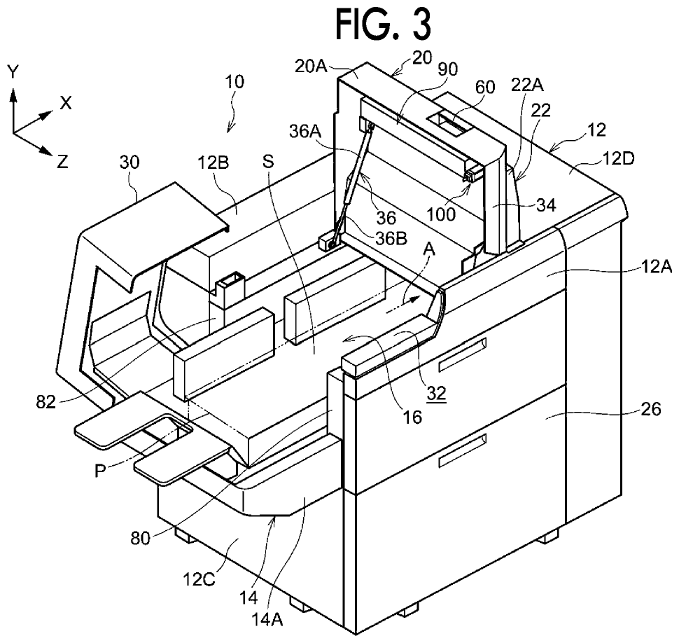

FIG. 2 is a perspective view showing the paper feeding device 10 according to the exemplary embodiment. As shown in FIG. 2, the paper feeding device 10 includes a main body portion 12 as an example of a device main body, and a housing device 14 that projects from the side of the main body portion 12 toward the outside of the main body portion 12. A loading unit 16 on which plural recording media P are loaded is provided inside the housing device 14 (see FIG. 3). The housing device 14 is configured to be retrofitted to the paper feeding device 10 as an option.

As shown in FIGS. 2 and 3, the paper feeding device 10 is provided at an upper portion of the main body portion 12, and includes an opening and closing member 20 that opens and closes a loading space S on the loading unit 16 and a damper 36 that assists an opening operation of the loading space S by the opening and closing member 20 (see FIG. 3). The paper feeding device 10 includes a latch mechanism 100 that holds a state in which the loading space S is closed by the opening and closing member 20 (see FIG. 3). In addition, the paper feeding device 10 includes a rotating member 22 that is disposed so as to overlap the opening and closing member 20 and that is rotatable. An opening/closing cover 30 (to be described later) that opens and closes the loading space S on the loading unit 16 is provided at a portion of the housing device 14 that projects out beyond the side of the main body portion 12.

Furthermore, the paper feeding device 10 includes a drawer tray 26 in which a recording medium (not shown) different from the recording medium P is stored at a lower portion on the front side of the main body portion 12 in the depth direction (that is, the Z direction). The drawer tray 26 is configured to store a recording medium (not shown) different from the recording medium P by being pulled out from the main body portion 12.

Configuration of Main Body Portion 12

As shown in FIGS. 2 and 3, the main body portion 12 has a function as an outer casing of the paper feeding device 10. The main body portion 12 includes a front wall 12A disposed on the front side in the device depth direction (that is, the Z direction) and a rear wall 12B disposed on the back side in the device depth direction. In addition, the main body portion 12 includes a side wall 12C disposed on one side in the device width direction (that is, the X direction) and a side wall (not shown in FIG. 2) disposed on the other side in the device width direction. The front wall 12A is composed of plural panels. Here, the front wall 12A and the rear wall 12B are an example of a pair of walls. In addition, the front wall 12A is an example of one wall. The drawer tray 26 is provided in a range excluding the upper side of the front wall 12A and the other side of the front wall 12A in the device width direction.

In addition, the main body portion 12 includes the front wall 12A, the rear wall 12B, the side wall 12C, and an upper wall 12D disposed on the other side wall (not shown in FIG. 2). The upper wall 12D is disposed only on the other side in the device width direction. The upper ends of the front wall 12A and the rear wall 12B are connected to the upper wall 12D, and a part of the loading space S is covered by the upper wall 12D.

As shown in FIG. 3, the main body portion 12 is provided with a frame portion 80 as an example of a supporting body that supports the front wall 12A from the inside in the device depth direction (that is, the Z direction) (see FIG. 3). Furthermore, the main body portion 12 is provided with a frame portion 82 as an example of a supporting body that supports the rear wall 12B from the inside in the device depth direction (that is, the Z direction).

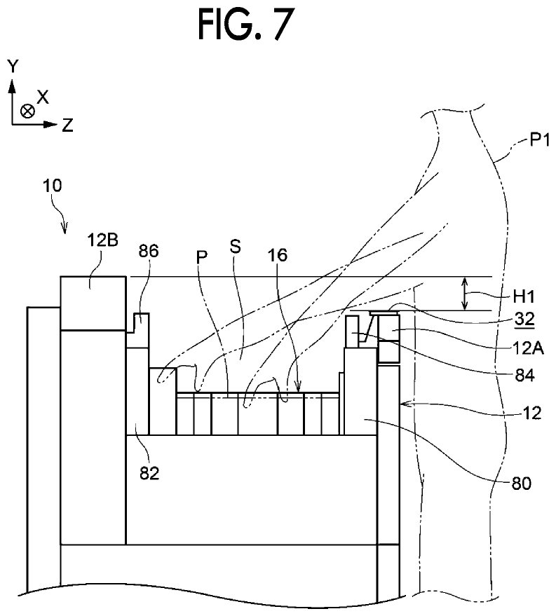

The front wall 12A and the rear wall 12B are provided on both sides in a direction intersecting with the transport direction of the recording medium P, that is, in the device depth direction indicated by the arrow Z such that the loading space S on the loading unit 16 is interposed therebetween. In addition, the front wall 12A is provided with a cutout part 32 in which the height of a portion opposite to the upper wall 12D is lower than the height of another portion joined to the upper wall 12D. In other words, the cutout part 32 has an upstream portion located upstream in the direction of transport of the recording medium P loaded on the loading unit 16 (namely, the arrow A direction shown in FIG. 3), described later, and a downstream portion located downstream in the direction of transport of the recording media P, in which the height of the upstream portion is lower than the height of the downstream portion. The height of the upper surface of the cutout part 32 is higher than the height of the upper surface of the frame portion 80. Furthermore, in the present exemplary embodiment, the height of the upper surface of the cutout part 32 is higher than the height of the upper surface of a bracket 84 (to be described later) attached to the upper side of the frame portion 80 (see FIG. 7). Accordingly, the frame portion 80 and the bracket 84 do not protrude from the upper surface of the cutout part 32.

Configuration of Housing Device 14

The housing device 14 has a function of housing the plural recording media P. As shown in FIGS. 2 and 3, the housing device 14 projects from the upper side of the side wall 12C of the main body portion 12 toward the outside of the main body portion 12. The housing device 14 is disposed across the position between the front wall 12A and the rear wall 12B and the outside of the side wall 12C. The housing device 14 includes a main body portion 14A and the opening/closing cover 30 provided on the upper side of the main body portion 14A.

A loading unit 16 on which plural recording media P are loaded is provided inside the housing device 14 (see FIG. 3). In the present exemplary embodiment, it is assumed that the recording medium P loaded on the loading unit 16 is a recording medium longer than the length of the A3-sized recording medium in a longitudinal direction. For example, it is assumed that the length of the recording media P in the longitudinal direction is 900 mm or 1200 mm.

In the paper feeding device 10, the recording media P loaded on the loading unit 16 are transported one sheet at a time in the arrow A direction by a paper feeding unit (not shown) disposed on the upper wall 12D inside the main body portion 12. The loading unit 16 projects upstream of the front wall 12A and the rear wall 12B in the transport direction (that is, the arrow A direction) of the recording medium P. That is, in the paper feeding device 10, the upper portion of the side wall 12C in the space between the front wall 12A and the rear wall 12B is open upstream in the transport direction of the recording medium P, and the loading unit 16 is disposed straddling the opened portion.

The opening/closing cover 30 is configured to rotate in the device depth direction by a hinge (not shown) provided on the back side of the main body portion 14A in the device depth direction (that is, the Z direction) (see FIG. 3). It is configured such that a part of the loading space S on the loading unit 16 is opened by rotating the opening/closing cover 30 upward from the front side to the back side in the device depth direction (Z direction).

Configuration of Opening and Closing Member 20

The opening and closing member 20 has a function of opening the loading space S on the loading unit 16 by sharing with the opening/closing cover 30 in order to dispose the plural recording media P on the loading unit 16. As shown in FIGS. 2 and 3, the opening and closing member 20 is provided between the upper portions of the front wall 12A and the rear wall 12B. In the present exemplary embodiment, the opening and closing member 20 is provided at a position adjacent to the upper wall 12D of the main body portion 12.

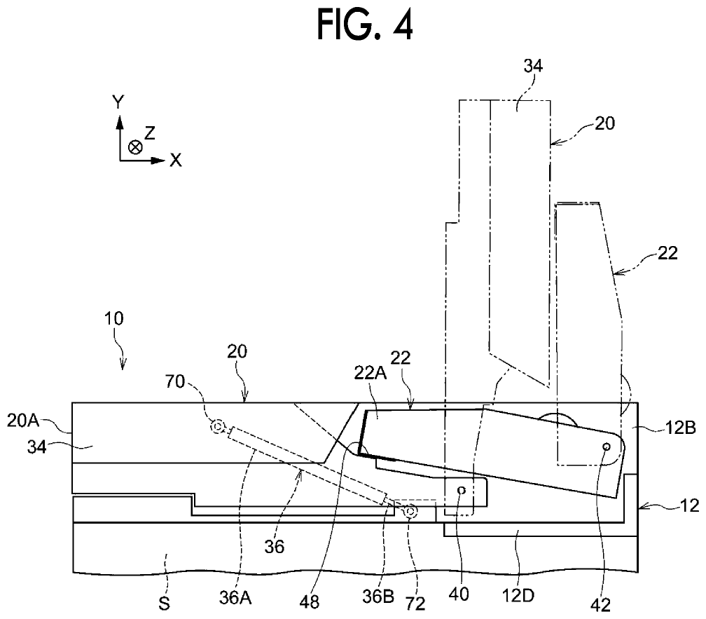

As shown in FIG. 4, the opening and closing member 20 is configured to rotate around a first hinge 40 provided on the downstream side in the transport direction (that is, the arrow A direction shown in FIG. 3) of the recording medium P and open and close the loading space S on the loading unit 16 (see FIG. 3). Here, the first hinge 40 is an example of a hinge. The first hinge 40 extends in a direction intersecting with the transport direction of the recording medium P (that is, in the device depth direction indicated by the arrow Z). The first hinge 40 is provided on the end edge side of the upper wall 12D (see FIG. 2) which is one end side of the front wall 12A and the rear wall 12B in the device width direction. As an example, one end portion of the first hinge 40 in the longitudinal direction is supported by the frame portion 80 supporting the front wall 12A, and the other end portion of the first hinge 40 in the longitudinal direction is supported by the frame portion 82 supporting the rear wall 12B (see FIG. 3).

In a state where the loading space S is closed, the opening and closing member 20 covers from the upper wall 12D to the end portions of the front wall 12A and the rear wall 12B on the upstream side in the transport direction (that is, the arrow A direction shown in FIG. 3) of the recording medium P. In addition, the opening/closing cover 30 covers a portion that projects out beyond the front wall 12A and the rear wall 12B.

In addition, as shown in FIG. 4, a contact portion 48 that contacts a tip end portion 22A of a rotating member 22 is provided on the upper side of the opening and closing member 20. The contact portion 48 is configured to have a stepwise upward slope toward a tip end portion 20A side of the opening and closing member 20 (that is, the side opposite to the first hinge 40 shown in FIG. 4).

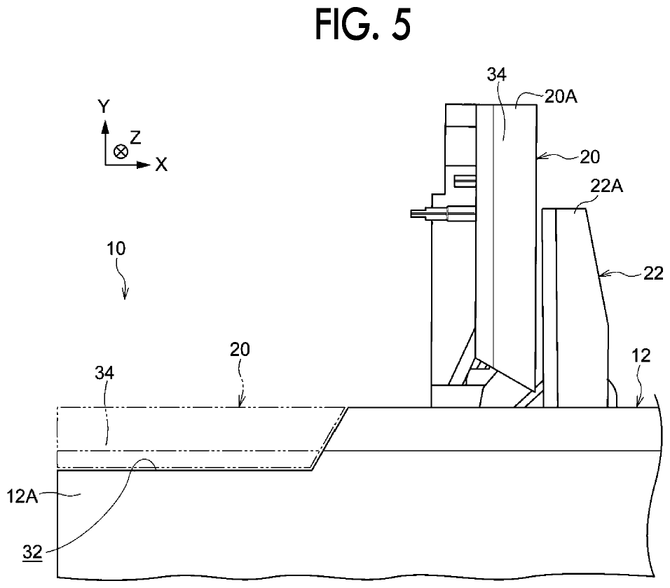

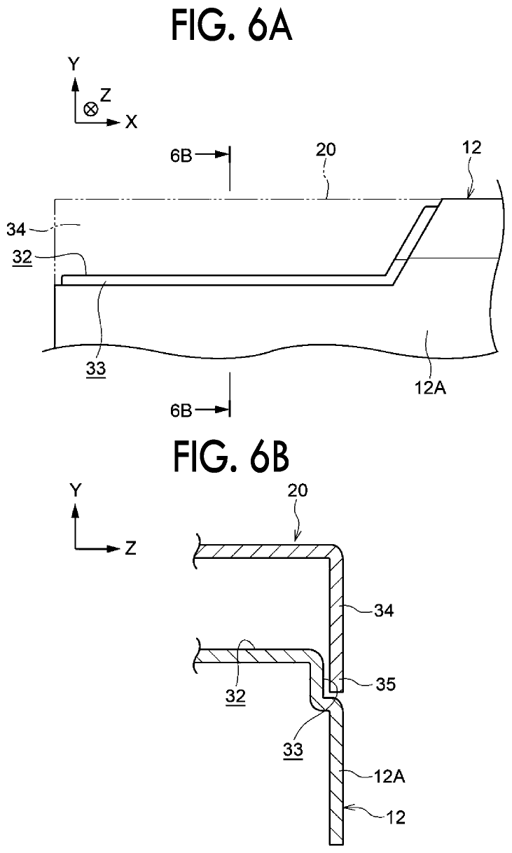

As shown in FIG. 5 and FIGS. 6A and 6B, a projecting portion 34 that projects from the edge of the opening and closing member 20 in the closed state of the loading space S and that fills a gap between the cutout part 32 and the edge of the opening and closing member 20 is provided in the opening and closing member 20 (see FIG. 2). The projecting portion 34 is provided on the tip end portion 20A side of the opening and closing member 20.

As shown in FIGS. 6A and 6B, a recessed portion 33 that is recessed from the front wall 12A in the device depth direction (that is, the Z direction) is provided at the edge of the cutout part 32 on the front wall 12A side. The recessed portion 33 is formed at the boundary portion between the edge of the cutout part 32 and the front wall 12A. An overlapping portion 35 that overlaps the cutout part 32 in a direction intersecting with the transport direction of the recording medium P is provided at the lower end portion of the projecting portion 34 in the state where the loading space S is closed by the opening and closing member 20. In the present exemplary embodiment, in the state where the loading space S is closed by the opening and closing member 20, the overlapping portion 35 is inserted in the recessed portion 33, and the overlapping portion 35 and the recessed portion 33 are disposed to overlap in the device depth direction. In this state, the inside of the cutout part 32 cannot be seen from the lower portion of the overlapping portion 35. In addition, in the state where the loading space S is closed by the opening and closing member 20, the front surface of the front wall 12A and the front surfaces of the projecting portion 34 and the overlapping portion 35 are disposed in a vertical direction.

When the opening and closing member 20 opens the loading space S, the rotating member 22 overlapping the opening and closing member 20 rotates in a direction in which the rotating member stands up in conjunction with the opening of the paper feeding device 10. As shown in FIG. 7, in the paper feeding device 10, an operator P1 disposes the recording medium P from the front wall 12A side (that is, the drawer tray 26 side) on the loading unit 16 in the open state of the loading space S by the opening and closing member 20. In the present exemplary embodiment, the cutout part 32 is provided in the front wall 12A, so that the recording medium P can be easily disposed on the loading unit 16 from the front wall 12A side through the cutout part 32.

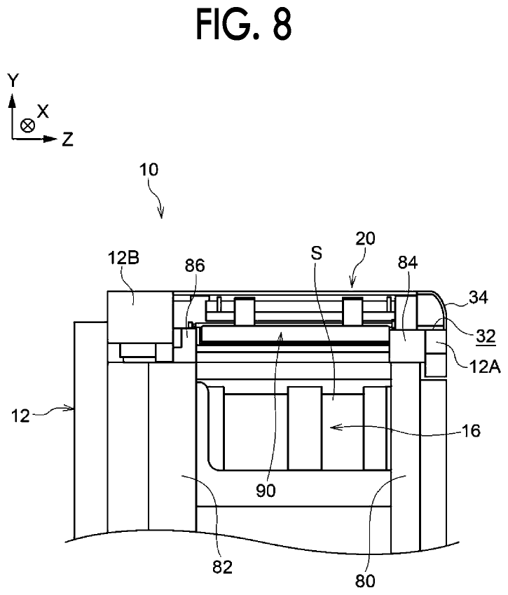

As shown in FIGS. 3 and 8, a reinforcing portion 90 disposed in the device depth direction (that is, the Z direction) is provided at the lower portion on the tip end portion 20A side of the opening and closing member 20. The reinforcing portion 90 is provided upstream of the opening and closing member 20 in the transport direction of the recording medium P (the arrow A direction shown in FIG. 3). The reinforcing portion 90 is configured to reinforce the frame portions 80 and 82 between the upper portions of the front wall 12A and the rear wall 12B in the state where the loading space S is closed by the opening and closing member 20.

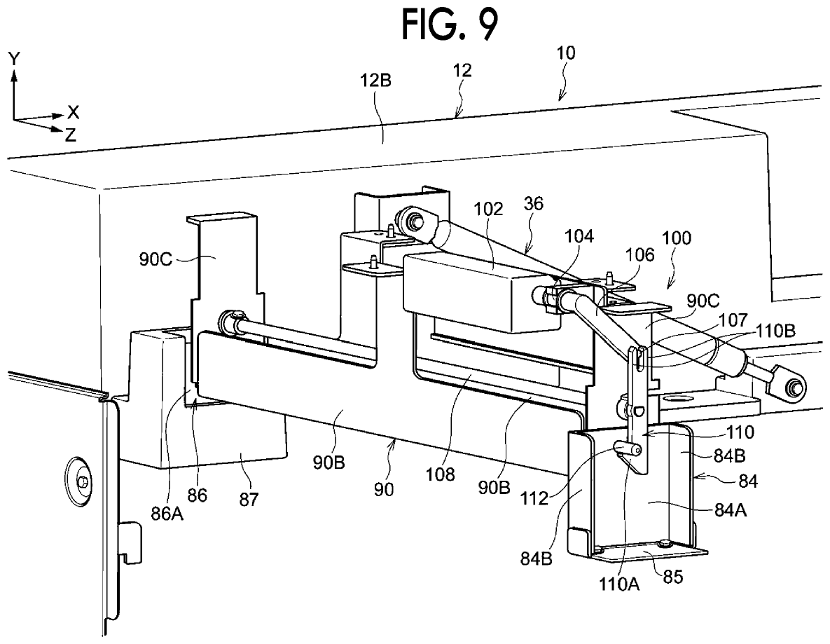

More specifically, as shown in FIG. 8, the bracket 84 is attached to the upper side of the frame portion 80, and a bracket 86 is attached to the upper side of the frame portion 82 (see FIG. 9). In FIG. 9, the frame portions 80 and 82 are not shown. In the present exemplary embodiment, the reinforcing portion 90 reinforces the frame portions 80 and 82 by entering between the bracket 84 on the upper side of the frame portion 80 and the bracket 86 on the upper side of the frame portion 82. Here, the bracket 84 is an example of a support portion and an attachment portion. In addition, the bracket 86 is an example of a supporting body.

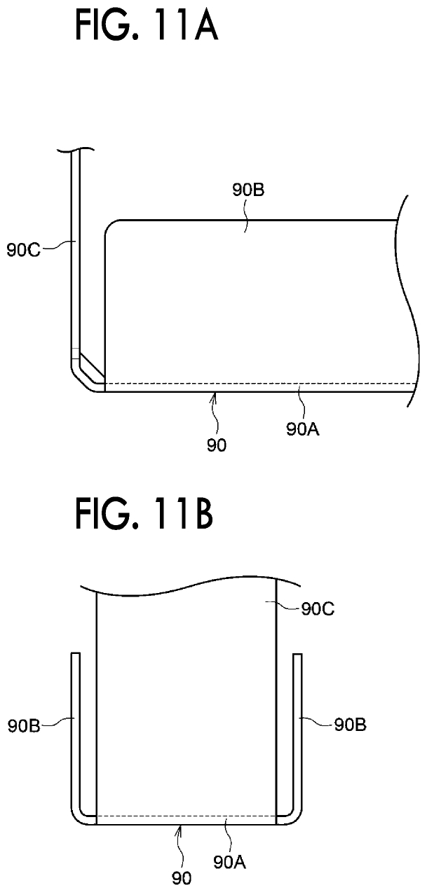

As shown in FIGS. 9 to 12, the reinforcing portion 90 has a U-shape opening on the upper side of the device in a sectional view in a direction intersecting with the device depth direction (that is, the arrow Z direction). The reinforcing portion 90 is made of, for example, a metal member. More specifically, the reinforcing portion 90 includes a bottom wall portion 90A disposed in the device depth direction, and a pair of side wall portions 90B bent upward from both sides in a direction intersecting with the bottom wall portion 90A in the longitudinal direction. Furthermore, the reinforcing portion 90 includes a pair of vertical wall portions 90C bent upward from the bottom wall portion 90A at both end portions of the bottom wall portion 90A in the longitudinal direction. The vertical wall portion 90C is flat. The vertical wall portion 90C is an example of an end surface of the reinforcing portion 90.

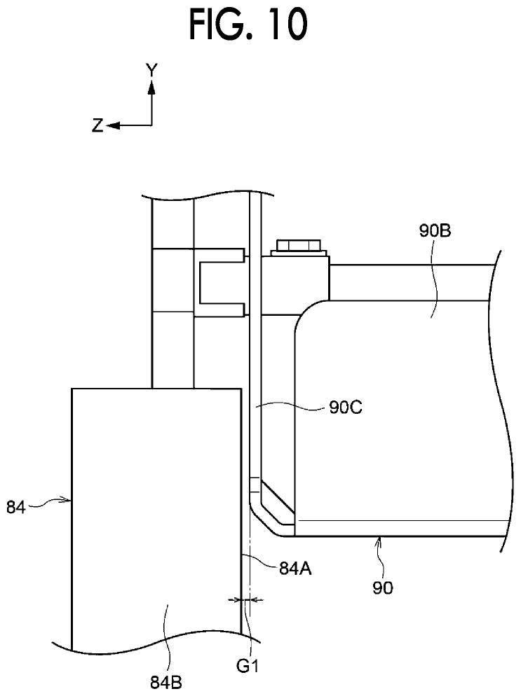

The bracket 84 is formed in a U-shape opening on the front side in the device depth direction (that is, the arrow Z direction) in a plan view (see FIG. 9). More specifically, the bracket 84 includes a flat side wall portion 84A as an example of a contact surface disposed in the device width direction (that is, the arrow X direction) and a pair of bent portions 84B bent on the front side in the device depth direction from both end portions of the side wall portion 84A (see FIG. 9). In the state where the loading space S is closed by the opening and closing member 20, the vertical wall portion 90C on the front side of the reinforcing portion 90 in the device depth direction (that is, the arrow Z direction) faces the side wall portion 84A of the bracket 84 (see FIG. 10). In the present exemplary embodiment, a gap G1 is formed between the vertical wall portion 90C of the reinforcing portion 90 and the side wall portion 84A of the bracket 84 in the state where the loading space S is closed by the opening and closing member 20 (see FIG. 10). Here, the gap G1 is preferably 0.5 mm or more and 5.0 mm or less, more preferably 0.7 mm or more and 3.0 mm or less, and still more preferably 0.9 mm or more and 2.0 mm or less. The bracket 84 is attached to the upper surface of the frame portion 80 using a fixing tool such as a bolt with an attachment portion 85 joined to the lower portion of the bracket 84. The vertical wall portion 90C on the front side of the reinforcing portion 90 is configured to abut on the side wall portion 84A when the bracket 84 and the frame portion 80 are slightly deformed in the device depth direction (that is, deformed by the amount of the gap G1).

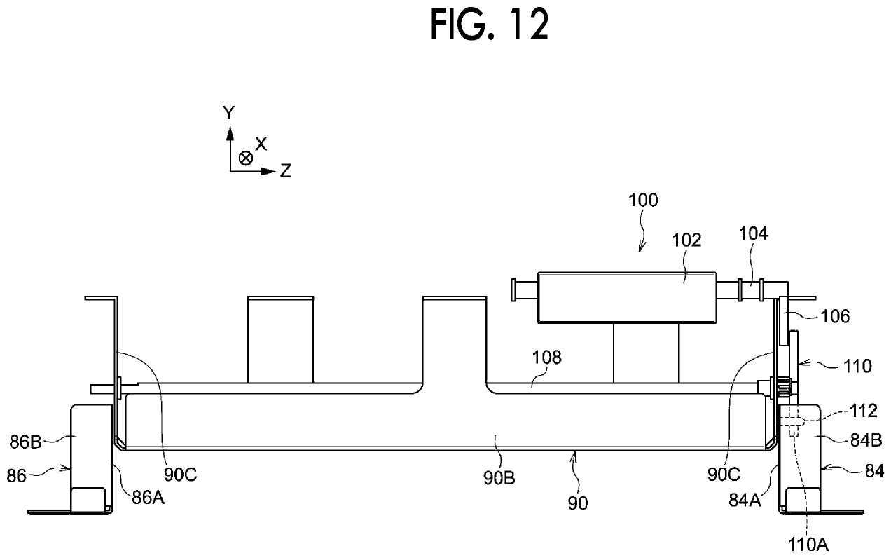

As shown in FIG. 12, the bracket 86 is formed in a U-shape opening on the back side in the device depth direction (that is, the arrow Z direction) in a plan view. More specifically, the bracket 86 includes a flat side wall portion 86A as an example of a contact surface disposed in the device width direction (that is, the arrow X direction) and a pair of bent portions 86B bent on the back side from both end portions of the side wall portion 86A in the device depth direction. In the state where the loading space S is closed by the opening and closing member 20, the vertical wall portion 90C on the back side of the reinforcing portion 90 in the device depth direction (that is, the arrow Z direction) faces the side wall portion 86A of the bracket 86. In the present exemplary embodiment, a gap is formed between the vertical wall portion 90C on the back side of the reinforcing portion 90 and the side wall portion 86A of the bracket 86 in the state where the loading space S is closed by the opening and closing member 20. The gap is preferably 0.5 mm or more and 5.0 mm or less, more preferably 0.7 mm or more and 3.0 mm or less, and still more preferably 0.9 mm or more and 2.0 mm or less. The bracket 86 is attached to the upper surface of the frame portion 82 using a fixing tool such as a bolt with a box shaped attachment portion 87 (see FIG. 9). The vertical wall portion 90C on the back side of the reinforcing portion 90 is configured to abut on the side wall portion 86A when the bracket 86 and the frame portion 82 are slightly deformed in the device depth direction (that is, deformed by the amount of the gap).

Configuration of Rotating Member 22

The rotating member 22 has a function of disposing a recording medium for manual feeding (not shown) different from the recording medium P. As shown in FIG. 4, the rotating member 22 is configured to rotate around a second hinge 42 provided on the downstream side in the transport direction (that is, the arrow A direction shown in FIG. 3) of the recording medium P from the first hinge 40. The second hinge 42 extends in a direction intersecting with the transport direction (that is, the arrow A direction shown in FIG. 3) of the recording medium P. As an example, one end portion of the second hinge 42 in the longitudinal direction is supported by the frame portion 80, and the other end portion of the second hinge 42 in the longitudinal direction is supported by the frame portion 82. The second hinge 42 is provided on the upper wall 12D side (see FIG. 2) which is one end side of the front wall 12A and the rear wall 12B in the device width direction from the first hinge 40.

In the closed state of the rotating member 22, the rotating member 22 is overlapped on the opening and closing member 20 that has closed the loading space S. In this state, the tip end portion 22A of the rotating member 22 is in contact with the contact portion 48 of the rotating member 22.

The rotating member 22 is configured to shift from a posture overlapping the opening and closing member 20 to a standing posture due to an operation of opening the loading space S by the opening and closing member 20. That is, the rotating member 22 is configured to rotate in a direction of standing up while the rotating member 22 slides with the contact portion 48 of the opening and closing member 20 due to the operation of opening the loading space S by the opening and closing member 20. In the paper feeding device 10, when the opening and closing member 20 is in a closed position, only the rotating member 22 can be rotated in a standing direction, but there is no practical meaning to use only the rotating member 22 in the standing state. For this reason, generally, either the opening and closing member 20 and the rotating member 22 are in the open position together, or the opening and closing member 20 and the rotating member 22 are in the closed position together.

The inner surface of the tip end portion 22A of the rotating member 22 slides with the contact portion 48 of the opening and closing member 20 when the opening and closing member 20 is open. A concave portion 54 in which a recording medium for manual feeding (not shown) is disposed between a pair of frame portions 50 is provided at the upper portion of the rotating member 22 (see FIG. 2). In FIG. 2, the frame portion 50 on the front side is not shown. A paper feeding unit (not shown) for feeding the recording medium for manual feeding disposed in the concave portion 54 of the rotating member 22 one sheet at a time is provided inside the upper wall 12D of the paper feeding device 10.

Configuration of Damper 36

The damper 36 has a function of assisting the opening operation of the loading space S by the opening and closing member 20 as described above. As shown in FIGS. 3 and 4, the damper 36 includes a cylindrical damper main body 36A and a rod 36B provided so as to be movable back and forth from the damper main body 36A. The end portion of the damper main body 36A opposite to the rod 36B is supported by an attachment portion 70 on the opening and closing member 20. The tip end portion of the rod 36B (that is, the end portion opposite to the damper main body 36A) is supported by an attachment portion 72 on the rear wall 12B. The attachment portion 70 rotatably supports the damper main body 36A and the opening and closing member 20 relative to each other. The attachment portion 72 rotatably supports the rod 36B and the rear wall 12B relative to each other.

In the present exemplary embodiment, one damper 36 is provided on the back side of the paper feeding device 10 in the depth direction (that is, the Z direction). A damper is not provided on the front wall 12A side which is the front side of the paper feeding device 10 in the depth direction (that is, the Z direction). The damper 36 is configured such that the rod 36B is pushed in a direction in which the rod 36B advances with respect to the damper main body 36A, and when the opening and closing member 20 is lifted halfway in the direction of opening the loading space S, the opening and closing member 20 is lifted by the action of the damper 36.

Configuration of Latch Mechanism 100

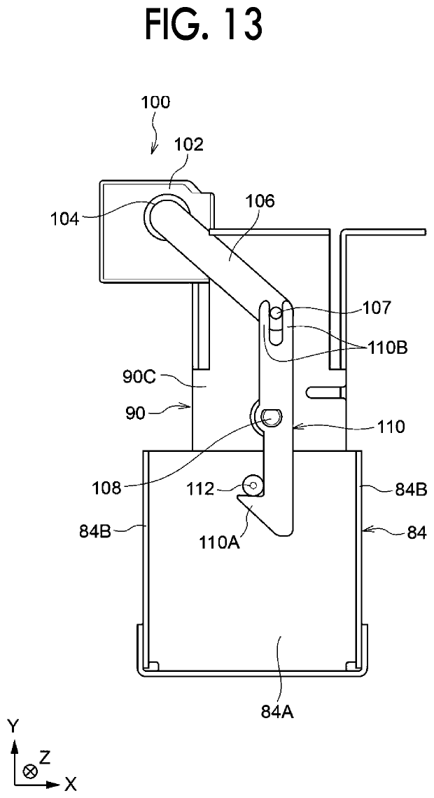

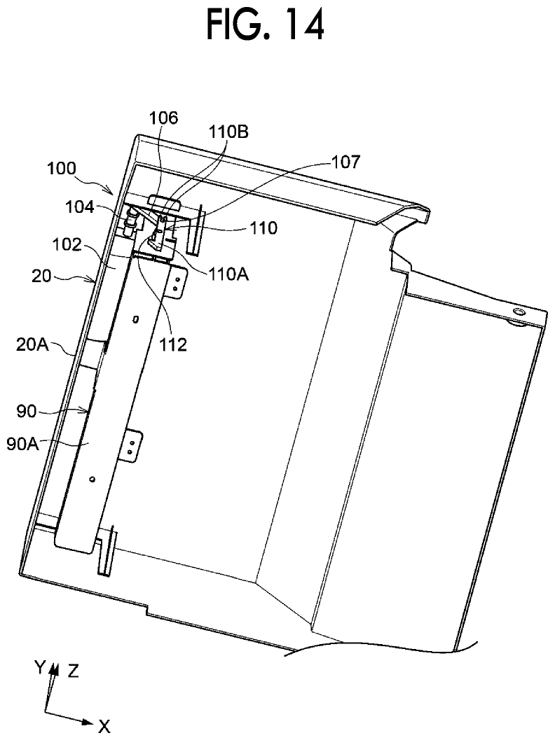

The latch mechanism 100 has a function of locking the opening and closing member 20 to the main body portion 12 side at the closed position of the loading space S by the opening and closing member 20. As shown in FIG. 9 and FIGS. 12 to 14, the latch mechanism 100 is provided on the reinforcing portion 90 side in the opening and closing member 20. The latch mechanism 100 includes a main body portion 102 and an arm portion 106 which is swung by a rotating shaft 104 provided on the main body portion 102. In addition, the latch mechanism 100 includes a shaft portion 108 extended around the pair of vertical wall portions 90C of the reinforcing portion 90, and a latch 110 rotatably supported at one end portion of the shaft portion 108 in an axial direction (in the present exemplary embodiment, the end portion on the front side in the device depth direction).

The latch 110 is a long plate shaped member, and an intermediate portion thereof in the longitudinal direction is rotatably supported at one end portion of the shaft portion 108 in the axial direction. A hook 110A is provided at one end portion of the latch 110 in the longitudinal direction (in the present exemplary embodiment, the lower end portion when the opening and closing member 20 is closed). A pair of support pieces 110B are provided at the other end portion of the latch 110 in the longitudinal direction (in the present exemplary embodiment, the upper end portion when the opening and closing member 20 is closed). In addition, a rod-like portion 107 is interposed between the pair of support pieces 110B such that the rod-like portion 107 protruding from the tip end portion of the arm portion 106 is rotatable and is movable in the longitudinal direction of the latch 110.

The bracket 84 is provided with a rod 112 as an example of a lock portion that protrudes from the side wall portion 84A toward the front side in the device depth direction. The hook 110A of the latch 110 is locked to the rod 112 of the bracket 84 to hold the state in which the loading space S is closed by the opening and closing member 20 (that is, lock the opening and closing member 20 in the closed position). The rod 112 is disposed inside the bracket 84.

In the latch mechanism 100, in a state where the rod-like portion 107 of the arm portion 106 is interposed between the pair of support pieces 110B of the latch 110, the latch 110 rotates in the device width direction (that is, the arrow X direction) around the shaft portion 108 by swinging of the arm portion 106. Accordingly, the latch 110 rotates to a locked position where the hook 110A is locked to the rod 112 of the bracket 84 and a lock release position where the hook 110A is disengaged from the rod 112 of the bracket 84.

As shown in FIG. 2, the tip end portion 20A of the opening and closing member 20 is provided with a handle 60 for releasing the locking of the opening and closing member 20 to the main body portion 12 in the state where the loading space S is closed by the opening and closing member 20. In the present exemplary embodiment, the handle 60 is provided on the front wall 12A side of the opening and closing member 20 in the depth direction (that is, the Z direction). The handle 60 is configured to rotate, for example, in the vertical direction. Although not shown, the handle 60 is coupled to the rotating shaft 104 of the latch mechanism 100 to rotate the rotating shaft 104. The rotating shaft 104 is configured to swing the arm portion 106 by a biasing member (not shown) in a direction in which the hook 110A of the latch 110 is locked to the rod 112 of the bracket 84. For example, the handle 60 is lifted upward, the rotation of the rotating shaft 104 causes the arm portion 106 to swing in a lock release direction, and thus the hook 110A of the latch 110 is disengaged from the rod 112 of the bracket 84. Accordingly, the locking of the opening and closing member 20 to the main body portion 12 is released, and the opening and closing member 20 is configured to be rotatable in the direction of opening the loading space S.

Actions and Effects

Next, the actions and effects of the present exemplary embodiment will be described.

In the paper feeding device 10, in the general state, the opening and closing member 20 is in the closed position, and the loading space S on the loading unit 16 is closed by the opening and closing member 20 (see FIG. 2). In this state, the rotating member 22 is disposed at a position overlapping the opening and closing member 20.

In the paper feeding device 10, when the recording medium P is disposed on the loading unit 16, the opening and closing member 20 rotates around the first hinge 40 to open the loading space S on the loading unit 16 (see FIG. 3). Due to the operation of opening the loading space S by the opening and closing member 20, the rotating member 22 rotates around the second hinge 42 to shift from the posture overlapping the opening and closing member 20 to the standing posture.

Furthermore, the opening/closing cover 30 of the housing device 14 is rotated from the front side to the back side in the device depth direction to open the loading space S on the loading unit 16 (see FIG. 3). In this state, as shown in FIG. 7, the operator P1 disposes the plural recording media P on the loading unit 16 from the front wall 12A side of the main body portion 12. In this case, the cutout part 32 is formed at the front wall 12A. The cutout part 32 has the height of the upstream portion in the transport direction (that is, the arrow A direction shown in FIG. 3) of the recording medium P lower than the height of the downstream portion in the transport direction of the recording medium P. Accordingly, the height of the upper surface of the cutout part 32 is lower than the heights of the portion of the front wall 12A where the cutout part 32 is not formed and the upper surface of the rear wall 12B by a height H1. Therefore, by disposing the plural recording media P from the cutout part 32 of the front wall 12A to the loading unit 16, the recording media P can be easily disposed on the loading unit 16.

Thereafter, the opening and closing member 20 is rotated to close the loading space S on the loading unit 16, and the rotating member 22 is rotated to a position overlapping the opening and closing member 20. In addition, the opening/closing cover 30 of the housing device 14 is rotated to close the loading space S on the loading unit 16. In this state, the paper feeding device 10 is operated to transport the recording medium P to the image forming apparatus main body 202. The image forming apparatus main body 202 forms an image on the transported recording medium P.

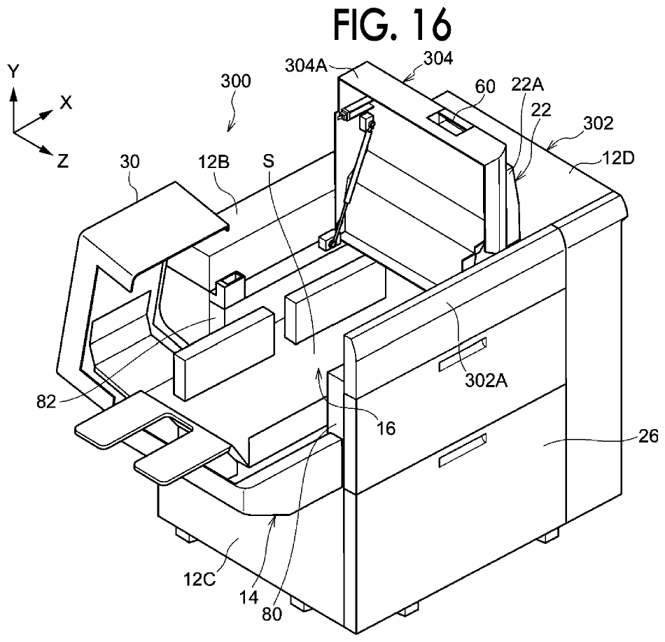

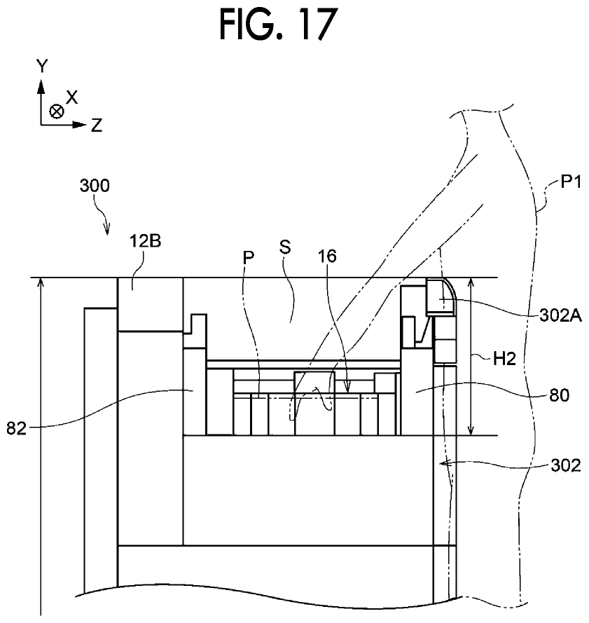

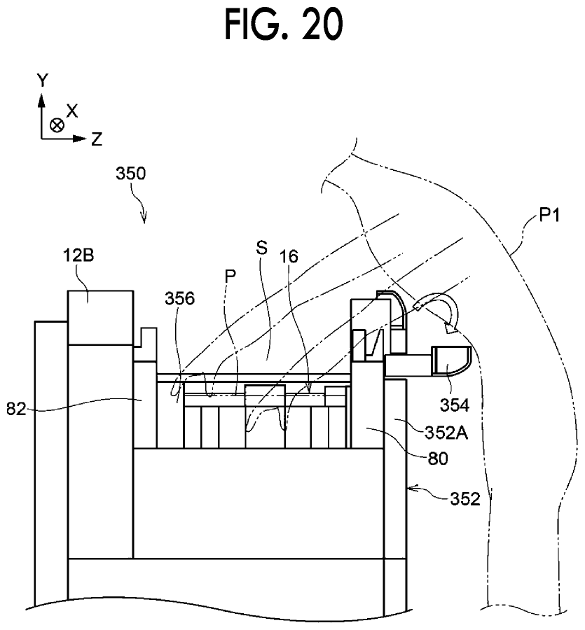

Here, a paper feeding device 300 of a first comparative example will be described with reference to FIGS. 16 and 17. In addition, a paper feeding device 350 of a second comparative example will be described with reference to FIG. 20.

As shown in FIG. 16, the paper feeding device 300 of the first comparative example includes a main body portion 302, a housing device 14 that projects out beyond the side of the main body portion 302, and an opening and closing member 304 that is provided at the upper portion of the main body portion 302 and that opens and closes a loading space S on a loading unit 16. In addition, the paper feeding device 300 includes a rotating member 22 that is disposed so as to overlap the opening and closing member 304.

The main body portion 302 includes a front wall 302A disposed on the front side in the device depth direction (that is, the Z direction) and a rear wall 12B disposed on the back side in the device depth direction. The upper surface of the front wall 302A is set at the same height along the device width direction (that is, the X direction). In addition, the height of the upper surface of the front wall 302A is equal to the height of the upper surface of the rear wall 12B.

In the paper feeding device 300, as shown in FIG. 17, when the recording medium P is disposed on the loading unit 16, the opening and closing member 304 is rotated to open the loading space S on the loading unit 16. In this state, an operator P1 disposes plural recording media P on the loading unit 16 from the front wall 302A side of the main body portion 302. In this case, since the height of the upper surface of the front wall 302A is equal along the device width direction (that is, the X direction), a height H2 from the lower surface of the recording medium P to the upper surface of the front wall 302A is high. As an example, the height H2 is about 324 mm, and the height of the entire paper feeding device 300 in the vertical direction is about 991 mm. Therefore, the operator P1 does not easily access the back side of the loading unit 16 in the device depth direction (that is, the Z direction), and the recording medium P is not easily disposed on the loading unit 16.

In addition, as shown in FIG. 20, in the paper feeding device 350 of the second comparative example, a rotating unit 354 that rotates from a standing position on the upper side of a front wall 352A to a tilted position on the front side in the device depth direction by a hinge (not shown) is provided at the upper portion of the front wall 352A of a main body portion 352.

In the paper feeding device 350, the plural recording media P are disposed on the loading unit 16 from the front wall 352A side in a state where the rotating unit 354 is rotated to the tilted position on the front side in the device depth direction with respect to the front wall 352A. Therefore, in the paper feeding device 350, the operation of rotating the rotating unit 354 is added. In addition, since the rotating unit 354 protrudes to the front side of the device from the front wall 352A, the operator P1 does not easily access a side guide 356 on the back side of the loading unit 16 in the device depth direction (that is, the Z direction).

In contrast, in the paper feeding device 10 of the present exemplary embodiment, the cutout part 32 is formed at the front wall 12A of the main body portion 12. The cutout part 32 has the height of the upstream portion in the transport direction (that is, the arrow A direction shown in FIG. 3) of the recording medium P lower than the height of the downstream portion in the transport direction of the recording medium P. Accordingly, as shown in FIG. 7, the height of the upper surface of the cutout part 32 is lower than the height of the portion of the front wall 12A where the cutout part 32 is not formed by the height H1. Therefore, the operator P1 easily accesses the back side of the loading unit 16 in the device depth direction (that is, the Z direction) from the cutout part 32 of the front wall 12A.

Therefore, in the paper feeding device 10, the workability at the time of disposing the recording medium P on the loading unit 16 is improved as compared with the configuration in which the upper surface of one wall of a pair of walls has the same height.

In addition, in the paper feeding device 10, the drawer tray 26 that stores a recording medium different from the recording medium P is provided below the front wall 12A. Therefore, in the paper feeding device 10, the recording medium P can be disposed on the loading unit 16 from the drawer tray 26 side.

Further, in the paper feeding device 10, the loading unit 16 projects upstream of the front wall 12A and the rear wall 12B in the transport direction (that is, the arrow A direction) of the recording medium P, and a space between the front wall 12A and the rear wall 12B is open upstream in the transport direction of the recording medium P. Therefore, in the paper feeding device 10, the size of the paper feeding device 10 can be reduced as compared with a configuration having a pair of walls between which the entire loading space is interposed.

In addition, in the paper feeding device 10, the projecting portion 34 is provided which projects from the opening and closing member 20 and which fills a gap between the cutout part 32 and the opening and closing member 20 in the state where the loading space S is closed by the opening and closing member 20. Therefore, in the paper feeding device 10, the inside of the device can be prevented from being seen through the cutout part 32 in the state where the loading space S is closed by the opening and closing member 20 as compared with the configuration in which the lower surface of the opening and closing member has a uniform shape.

In addition, in the paper feeding device 10, the overlapping portion 35 that overlaps the cutout part 32 in a direction intersecting with the transport direction of the recording medium P is provided at the edge of the projecting portion 34 in the state where the loading space S is closed by the opening and closing member 20. Therefore, in the paper feeding device 10, the inside of the device can be prevented from being seen through the space between the projecting portion 34 and the cutout part 32 as compared with the configuration in which the projecting portion and the cutout part do not overlap in the state where the loading space is closed by the opening and closing member.

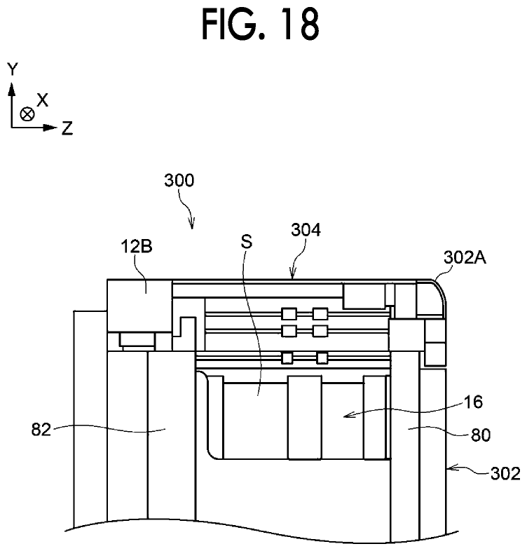

Here, the paper feeding device 300 of the first comparative example will be described with reference to FIGS. 16, 18, and 19. As shown in FIG. 16, in the paper feeding device 300 of the first comparative example, the inside of a tip end portion 304A of the opening and closing member 304 is formed of, for example, a resin member in a planar shape. That is, as shown in FIG. 18, in the state where the loading space S above the loading unit 16 is closed by the opening and closing member 304, a reinforcing portion disposed between a frame portion 80 and a frame portion 82 on both sides of the main body portion 302 in the depth direction is not provided inside the tip end portion 304A of the opening and closing member 304.

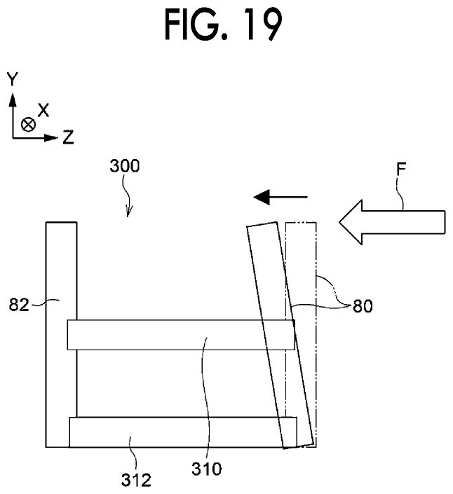

As shown in FIG. 19, in the paper feeding device 300, a horizontal frame portion 310 that connects the frame portion 80 and the frame portion 82 to each other is provided at an intermediate portion of the frame portion 80 and the frame portion 82 in the vertical direction. In addition, a lower horizontal frame portion 312 that connects the frame portion 80 and the frame portion 82 is provided at the lower end portion of the frame portion 80 and the frame portion 82. Note that, FIG. 19 schematically shows only the skeleton of the paper feeding device 300. Therefore, at the time of closing the opening and closing member 304 (see FIG. 18), when an external force in an arrow F direction (that is, a direction toward the back side of the device) is applied to the upper portion of the frame portion 80 on the front side of the device, the force is transmitted to the frame portion 82 from the frame portion 80 through the horizontal frame portion 310 of the intermediate portion in the vertical direction. As a result, the deformation of the frame portion 80 in the device depth direction is increased.

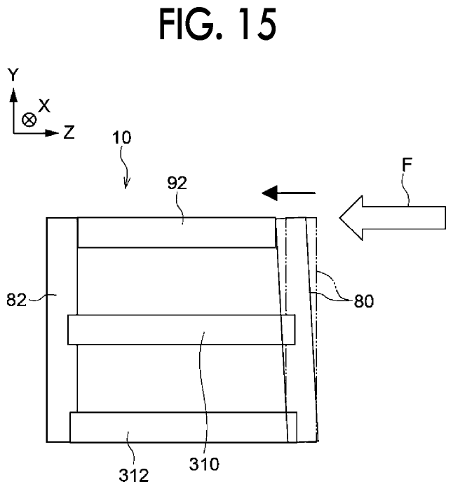

In contrast, in the paper feeding device 10 of the present exemplary embodiment, the reinforcing portion 90 is provided upstream of the opening and closing member 20 in the transport direction of the recording medium P, and reinforces the frame portions 80 and 82 between the upper portions of the front wall 12A and the rear wall 12B in the state where the loading space S is closed by the opening and closing member 20. Therefore, as shown in FIG. 15, at the time of closing the opening and closing member 20, when an external force in an arrow F direction (that is, a direction toward the back side of the device) is applied to the upper portion of the frame portion 80 on the front side of the device, the force is transmitted to the frame portion 82 from the frame portion 80 through the reinforcing portion 90. More specifically, when an external force in the arrow F direction is applied to the frame portion 80, the frame portion 80 is slightly deformed, the side wall portion 84A of the bracket 84 on the upper side of the frame portion 80 abuts on the vertical wall portion 90C of the reinforcing portion 90, and the force is transmitted from the frame portion 80 to the reinforcing portion 90 (see FIG. 12). Furthermore, the vertical wall portion 90C is slightly displaced on the back side of the reinforcing portion 90 in the device depth direction and abuts on the side wall portion 86A of the bracket 86 on the upper side of the frame portion 82, and the force is transmitted from the reinforcing portion 90 to the frame portion 82 (see FIG. 12). In this case, the amount of deformation of the frame portions 80 and 82 is reduced by the reinforcing portion 90 being stretched.

Therefore, in the paper feeding device 10, the deformation of the frame portions 80 and 82 and the brackets 84 and 86 is reduced as compared with the configuration in which the supporting body is not reinforced in the state where the loading space is closed by the opening and closing member.

In addition, in the paper feeding device 10, in the state where the loading space S is closed by the opening and closing member 20, the bracket 84 on the upper side of the frame portion 80 is provided with the side wall portion 84A facing the reinforcing portion 90, and the bracket 86 on the upper side of the frame portion 82 is provided with the side wall portion 86A facing the reinforcing portion 90. Therefore, in the paper feeding device 10, the deformation of the frame portions 80 and 82 and the brackets 84 and 86 is reduced as compared with the configuration in which the reinforcing portion does not abut on the supporting body.

In the paper feeding device 10, in the state where the loading space S is closed by the opening and closing member 20, the gap is provided between the vertical wall portion 90C on the front side of the reinforcing portion 90 and the side wall portion 84A, and the vertical wall portion 90C of the reinforcing portion 90 is configured to abut on the side wall portion 84A due to a slight deformation of the frame portion 80. Similarly, in the state where the loading space S is closed by the opening and closing member 20, the gap is provided between the vertical wall portion 90C on the back side of the reinforcing portion 90 and the side wall portion 86A, and the vertical wall portion 90C of the reinforcing portion 90 is configured to abut on the side wall portion 86A when the frame portion 82 is slightly deformed. Therefore, in the paper feeding device 10, the side wall portions 84A and 86A is prevented from interfering with the opening and closing of loading space S by the opening and closing member 20 in contrast to the configuration in which the end surface of the reinforcing portion abuts on the contact surface in the state where the loading space is closed by the opening and closing member.

In addition, in the paper feeding device 10, the latch 110 that holds the state in which the loading space S is closed by the opening and closing member 20 is provided on the reinforcing portion 90 side in the opening and closing member 20. Therefore, in the paper feeding device 10, a latch failure is less likely to occur as compared with the configuration in which the latch is provided on the side opposite to the reinforcing portion in the opening and closing member.

In the paper feeding device 10, the frame portion 80 is provided with the bracket 84 having the side wall portion 84A, and the bracket 84 is provided with the rod 112 to which the hook 110A of the latch 110 is locked. Therefore, in the paper feeding device 10, assembly of the rod 112 is facilitated as compared with the configuration which provides the lock portion with which the latch is locked to the frame portion as an example of the supporting body.

In addition, in the paper feeding device 10, the upper surface of the cutout part 32 is disposed above the frame portion 80 and the bracket 84. Therefore, in the paper feeding device 10, the appearance from the outside of the paper feeding device 10 is improved as compared with the configuration in which the upper surface of the cutout part is disposed below the attachment portion.

Furthermore, in the image forming apparatus 200 including the paper feeding device 10, the workability at the time of disposing the recording medium P on the loading unit 16 is improved as compared with the configuration in which the upper surface of one wall of the pair of walls has the same height.

Supplementary Explanation

In the exemplary embodiment, although the overlapping portion 35 that overlaps the cutout part 32 in a direction intersecting with the transport direction of the recording medium P is provided at the edge of the projecting portion 34, the present disclosure is not limited to the configuration. For example, the overlapping portion that overlaps the projecting portion in a direction intersecting with the transport direction of the recording medium P may be provided at the edge of the cutout part.

In the exemplary embodiment, the position, depth, and the like of the cutout part 32 are changeable. In addition, in the exemplary embodiment, the shape of the reinforcing portion 90 is changeable.

Although the handle 60 is provided on the front wall 12A side of the opening and closing member 20 in the device depth direction, the present disclosure is not limited thereto, and the handle may be provided near the central portion of the opening and closing member in the depth direction.

Although the present disclosure has been described in detail with respect to the specific exemplary embodiment, the present disclosure is not limited to such an exemplary embodiment, and it will be apparent to those skilled in the art that various other exemplary embodiments are possible within the scope of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paper feeding device comprising:
a loading unit on which a recording medium is loaded;
a pair of walls provided to define a loading space above the loading unit between both sides in a direction intersecting with a direction of transport of the recording medium;
an opening and closing member that is provided between upper portions of the pair of walls and opens and closes the loading space; and
a cutout part that is provided on one of the pair of walls and in which a portion located upstream in the transport direction is located lower than a portion located downstream in the transport direction.

2. The paper feeding device according to claim 1, further comprising:
a drawer tray that is provided below the one wall and stores a recording medium different from the recording medium.

3. The paper feeding device according to claim 1, wherein
the loading unit projects upstream of the pair of walls in the transport direction, and
a space between the pair of walls is open upstream in the transport direction.

4. The paper feeding device according to claim 1, further comprising:
a projecting portion that projects from the opening and closing member, and fills a gap between the cutout part and the opening and closing member in a state where the loading space is closed by the opening and closing member.

5. The paper feeding device according to claim 4, further comprising:
an overlapping portion that is provided at an edge of one of the cutout part and the projecting portion, and overlaps the other of the cutout part and the projecting portion in the intersecting direction in a state where the loading space is closed by the opening and closing member.

6. The paper feeding device according to claim 2, wherein
the opening and closing member is configured to open and close the loading space by rotating around a hinge disposed downstream in the transport direction,
the paper feeding device further comprising:
a supporting body that supports the pair of walls and the hinge; and
a reinforcing portion that is provided upstream of the opening and closing member in the transport direction, and reinforces the supporting body between upper portions of the pair of walls in a state where the loading space is closed by the opening and closing member.

7. The paper feeding device according to claim 6, wherein
the supporting body is provided with a contact surface that faces the reinforcing portion in the state where the loading space is closed by the opening and closing member.

8. The paper feeding device according to claim 7, wherein
in the state where the loading space is closed by the opening and closing member, a gap is formed between an end surface of the reinforcing portion and the contact surface, and
deformation of the supporting body allows the end surface of the reinforcing portion to abut on the contact surface.

9. The paper feeding device according to claim 7, wherein
a latch that holds the state in which the loading space is closed by the opening and closing member is provided in the opening and closing member on a reinforcing portion side.

10. The paper feeding device according to claim 9, wherein
the supporting body is provided with an attachment portion having the contact surface, and
the attachment portion is provided with a lock portion to which the latch is locked.

11. The paper feeding device according to claim 10, wherein an upper surface of the cutout part is disposed above the attachment portion.

12. An image forming apparatus comprising:
the paper feeding device according to claim 1, wherein
the recording medium is transported from the paper feeding device to an image forming unit.
